(19) United States
(12) Patent Application Publication
(10) Pub. No.: US 2007/0195720 A1
(43) Pub. Date: Aug. 23, 2007

(54) Data transmitting/receiving apparatus and received data analysis method

(76) Inventor: Takeshi Ichikawa, Tokyo (JP)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/706,202

(22) Filed: Feb. 15, 2007

(30) Foreign Application Priority Data
Feb. 17, 2006 (JP) 2006-040147

(51) Int. Cl. H04B 7/005

(52) U.S. Cl. 370/278

(57) ABSTRACT

The present invention provides a data transmitting/receiving apparatus which determines whether received data is destined therefor, and a received data analysis method thereof. In the data transmitting/receiving apparatus, a comparison circuit in a transmitter-receiver outputs any of real data related to part of reception data and all data related to all thereof in accordance with a reception data selection signal and supplies the same to a control circuit. Therefore, only the data necessary for reception processing by the control circuit is supplied, whereby the time required to perform a receiving operation by the present apparatus can be shortened and the efficiency of the receiving operation can be enhanced.

### BACKGROUND OF THE INVENTION

The present invention relates to a data transmitting/receiving apparatus such as a base station, a user terminal or the like which in a wireless network system, determines whether received data is destined for the present apparatus, and a received data analysis method thereof.

A data transmitting/receiving apparatus has heretofore been equipped with a transmitter-receiver that receives data by radio via an antenna. The transmitter-receiver converts the received radio wave to analog data and further performs demodulation processing thereon.

As such a transmitter-receiver, there is known one which detects a signal strength of received or reception data and makes it possible to determine based on the signal strength whether a received radio wave corresponds to the data to be received, and which causes a comparing section in the transmitter-receiver to compare the data subsequent to demodulation processing with preset data where the received radio wave is found to correspond to the data to be received from the above result of determination, thereby allowing the comparing section to determine whether the data is destined for the present apparatus.

The comparing section is configured including, for example, a comparison data storage register which stores therein comparison data such as a network address indicative of the apparatus per se, a reception shift register which fetches the received or reception data subsequent to demodulation therein, a comparator which compares the comparison data and the reception data, and a data output control circuit which outputs the reception data depending upon the result of comparison by the comparator.

The reception shift register stores a portion intended for comparison, of the fetched reception data in a register, performs serial/parallel conversion on the data stored in the register and parallel-transmits the so-processed data to the comparator. On the other hand, the reception shift register serially transmits the reception data to the data output control circuit.

When the coincidence between the register data and the comparison data is detected, the comparator determines that the reception data is destined for the apparatus per se. Thus, the comparator permits the output of the reception data to the data output control circuit and does not permit its output when other than it.

Only when the comparator permits the output of the reception data, the data output control circuit outputs the reception data obtained from the reception shift register. Thus, the data transmitting/receiving apparatus can process only the reception data destined for the apparatus per se.

A unique word detection circuit described in, for example, a patent document 1 (Japanese Unexamined Patent Publication No. Hei 3(1991)-78338) is capable of detecting a unique word from a reception burst signal by allowing a comparator to compare a bit string of the reception burst signal with a reference pattern with the number of allowable error bits as a detection determination threshold value.

In the conventional data transmitting/receiving apparatus, however, the transmitter-receiver supplies the serial output sent from the reception shift register to the corresponding control circuit as reception processing data as it is. Therefore, it takes time to transfer the data to the control circuit, and the data transmitting/receiving apparatus per se becomes slow in receiving operation.

### SUMMARY OF THE INVENTION

The present invention aims to provide a data transmitting/receiving apparatus that solves the drawbacks of such a prior art and shortens the time required to transfer received data to thereby improve the efficiency of its receiving operation, and a received data analysis method thereof.

According to one aspect of the present invention, for attaining the above object, there is provided a data transmitting/receiving apparatus comprising:

transmitting/receiving means for transmitting and receiving desired reception data and transmission data by radio waves; and

control means for controlling transmission/reception of the reception data and the transmission data and performing reception processing on reception processing data based on the reception data,

wherein the transmitting/receiving means includes comparing means for comparing data intended for comparison, corresponding to at least part of the reception data with predetermined comparison data to thereby determine whether the reception data is destined for the present apparatus, outputting the reception processing data when the reception data is destined for the present apparatus and supplying the same to the control means, and

wherein the comparing means outputs any of real data related to part of the reception data and all data related to all thereof as the reception processing data in accordance with a reception data selection signal set to the control means.

According to another aspect of the present invention, for attaining the above object, there is provided a method of analyzing reception data in a data transmitting/receiving apparatus wherein a transmitting/receiving section transmits and receives desired reception data and transmission data by radio waves, and a control section controls transmission/reception of the reception data and the transmission data and further performs reception processing on reception processing data based on the reception data, the method comprising:

a comparing step for allowing the transmitting/receiving section to compare data intended for comparison, corresponding to at least part of the reception data with predetermined comparison data to thereby determine whether the reception data is destined for the present apparatus, and allowing the transmitting/receiving section to output the reception processing data when the reception data is destined for the present apparatus and to supply the same to the control section,

wherein in the comparing step, any of real data related to part of the reception data and all data related to all thereof is outputted as the reception processing data in accordance with a reception data selection signal set to the control section.

According to the data transmitting/receiving apparatus of the present invention, a comparison circuit in a transmitter-receiver outputs any of real data related to part of received or reception data and all data related to all thereof in accordance with a reception data selection signal and supplies the same to a control circuit. Therefore, only data necessary for reception processing by the control circuit is supplied without notifying needless data. Thus, the time necessary for processing at the receiving operation by the present apparatus can be shortened and hence the efficiency of the receiving operation can be enhanced.

In the data transmitting/receiving apparatus of the present invention, when data intended for comparison in reception data and comparison data are compared, the comparison circuit can set comparison control data for respective bytes in disregard for an actual result of comparison such that they coincide with each other and compare desired bytes alone. Even when, for example, real data changes every reception data and a data length contained in the comparison-targeted data always changes, the comparison circuit can compare the data intended for comparison in disregard for the result of comparison for the data length. Further, the comparison circuit can recognize only the higher order of addresses contained in the data intended for comparison and neglect the lower order thereof. Thus, a flexible reception data comparison is realized.

Further, the data transmitting/receiving apparatus of the present invention supplies data intended for comparison to the control circuit as mask data with the result of comparison by the comparison circuit as a trigger. Therefore, information about data that changes every reception data can be obtained without analyzing a serial data output. Hence, the time required to perform such an analysis can be saved.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram showing one embodiment of a data transmitting/receiving apparatus according to the present invention;

FIG. 2 is a schematic diagram of a wireless network system to which the data transmitting/receiving apparatus according to the embodiment shown in FIG. 1 is applied;

FIG. 3 is a block diagram illustrating an example of a comparison circuit employed in the data transmitting/receiving apparatus according to the embodiment shown in FIG. 1;

FIG. 4 is a flowchart for describing a procedure of operations of the data transmitting/receiving apparatus according to the embodiment shown in FIG. 1;

FIG. 5 is a timing chart for describing a procedure of operations of the comparison circuit shown in FIG. 3;

FIG. 6 is a block diagram showing an example of a comparison executing section in the comparison circuit shown in FIG. 3;

FIG. 7 is a timing chart for describing a procedure of operations of the comparison executing section shown in FIG. 6;

FIG. 8 is a timing chart for describing a procedure of operations of the comparison executing section shown in FIG. 6;

FIG. 9 is a block diagram showing an example of the comparison executing section in the comparison circuit shown in FIG. 3; and

FIG. 10 is a timing chart for describing a procedure of operations of the comparison executing section shown in FIG. 9.

### DETAILED DESCRIPTION OF THE PREFERRED EMBODIMENTS

A preferred embodiment of a data transmitting/

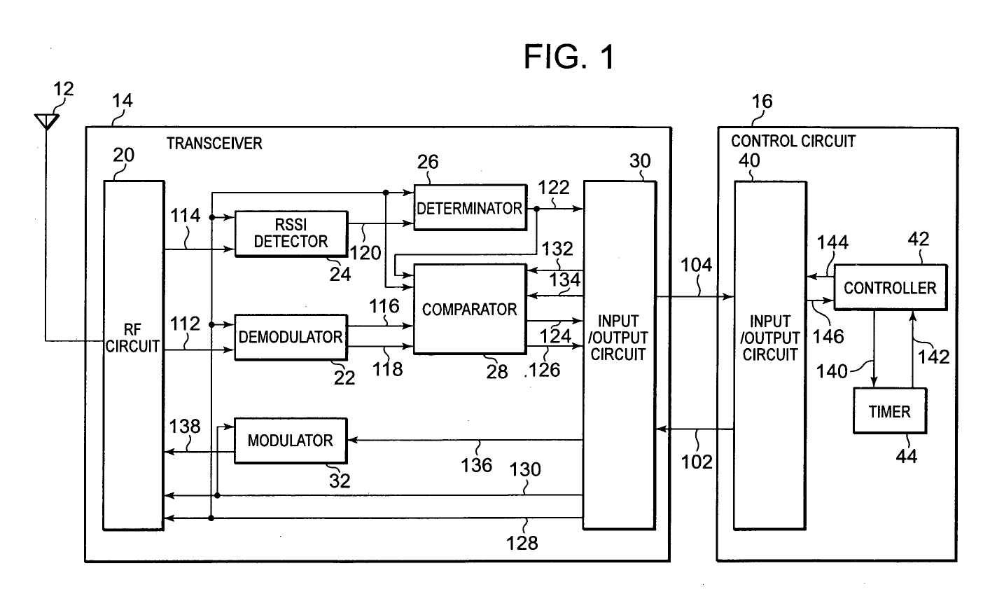

receiving apparatus according to the present invention will next be explained in detail with reference to the accompanying drawings. As shown in FIG. 1, for example, a data transmitting/receiving apparatus 10 is configured including a transceiver or transmitter-receiver 14 that transmits/receives data by radio via an antenna 12, and a control circuit 16 that controls the transmission/reception of the data at the transmitter-receiver 14. Incidentally, sections directly unrelated to the understanding of the present invention are not shown and their redundant explanations are therefore avoided.

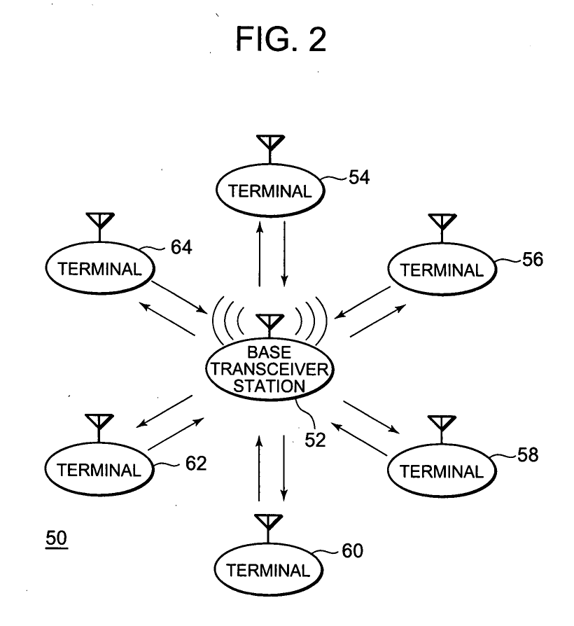

As shown in FIG. 2, for example, the data transmitting/receiving apparatus 10 is applied to a wireless network system 50. The wireless network system 50 comprises a base station 52 that uses the data transmitting/receiving apparatus, and a plurality of user terminals 54, 56, 58, 60, 62 and 64 each of which makes use of the data transmitting/receiving apparatus. The base station and the user terminals are communicated with one another by transmitting/receiving desired data by radio. The present apparatus 10 may notify transmission data to the user terminals when applied to the base station and may notify the transmission data to the base station when applied to the user terminals.

Although a large number of base stations and user terminals can actually be contained in the wireless network system 50, only a base station and a small number of user terminals are illustrated in FIG. 2 to avoid an increase in complexity.

The transmitter-receiver 14 of the present embodiment, particularly, an RF (Radio Frequency) circuit 20 converts a received radio wave into analog reception data. Further, a demodulator 22 effects demodulating processing on the reception data, and a receiving signal strength indicator (RSSI) detector 24 detects a signal strength of the reception data. A determinator 26 determines or judges based on the signal strength whether the radio wave corresponds to a radio wave to be received. A comparison circuit 28 compares the reception data sent from the demodulator 22 with comparison data according to the result of determination by the determinator 26 and determines whether the radio wave is destined for the present apparatus. The comparison circuit 28 outputs any of real data (payloader) related to part of the reception data, and all data (header and payloader) related to all thereof according to a reception data selection signal.

The transmitter-receiver 14 of the present embodiment is configured including an input/output circuit 30 connected to the control circuit 16 via connecting lines 102 and 104 to mutually transmit digital data, and a modulator 32 which performs modulation processing on the transmitted digital data. The transmitter-receiver 14 supplies a control signal 128 for instructing the reception by the input/output circuit 30 or a control signal 130 for instructing the transmission by the input/output circuit 30 to each section in response to a control signal 102 for instructing the reception or transmission from the control circuit 16, and executes transmission/reception of a radio wave by being operated according to the control signal 128 or 130.

In the present embodiment, the RF circuit 20 is configured with being connected to the antenna 12. The RF circuit 20 receives therein a radio wave, e.g., a high-frequency RF signal received by the antenna 12 and performs analog conversion thereof to produce analog reception data 112 and 114, followed by supply of the reception data to the demodulator 22 and the RSSI detector 24 respectively. Further, the RF circuit 20 converts analog transmission data 138 obtained from the modulator 32 to such a radio wave and supplies the same to the antenna 12.

The demodulator 22 performs demodulation processing on the analog reception data 112 supplied from the RF circuit 20, and particularly in the present embodiment, performs analog-to-digital conversion thereof to produce digital received or reception data 116 and supplies the same to the comparison circuit 28. Further, the demodulator 22 may supply demodulation clocks 118 for allowing itself to operate to the comparison circuit 28.

The RSSI detector 24 detects an RSSI value, i.e., the signal strength of the reception data 114, based on the reception data 114 supplied from the RF circuit 20 and effects analog-to-digital conversion thereon, followed by supply of digital data 120 indicative of the RSSI value to the determinator 26.

The determinator 26 determines based on the signal strength 120 supplied from the RSSI detector 24 whether the receiving operation of the present apparatus 10 should be continued or stopped. Thereafter, the determinator 26 supplies the result of determination 122 indicative of the continuation or stop of its receiving operation to the comparison circuit 28 and notifies it to the control circuit 16 via the input/output circuit 30.

In the present embodiment, the determinator 26 analyzes the signal strength 120, e.g., compares the signal strength 120 with a predetermined threshold value set in advance. When the signal strength is less than the threshold value, the determinator 26 judges that the radio wave corresponding to the source of the signal strength 120 is not worthy of reception. That is, the determinator 26 determines that the corresponding radio wave does not correspond to the radio wave desired to be received by the present apparatus 10, and outputs the result of determination 122 indicative of the stop of the receiving operation. When the signal strength 120 is greater than the threshold value, the determinator 26 judges that the receiving operation should be continued, and outputs the result of determination 122 indicative of the continuation of the receiving operation.

The comparison circuit 28 determines according to the result of determination 122 by the determinator 26 and the reception data 116 supplied from the demodulator 22 whether the corresponding received radio wave is destined for the present apparatus 10. Only when the result of determination 122 indicates the continuation of the receiving operation, the comparison circuit 28 of the present embodiment may perform such determination. The comparison circuit 28 takes, for example, part of the reception data 116, e.g., a portion indicative of information about a network address or the like as data intended for comparison and compares it with predetermined comparison data having information about the present apparatus, thereby making it possible to determine that the corresponding radio wave is destined for the present apparatus 10 where they coincide with each other. The comparison circuit 28 may preferably store such predetermined comparison data therein in advance.

When the received radio wave is destined for the present apparatus 10, the comparison circuit 28 outputs reception processing data 124 based on the reception data 116. When other than it, the comparison circuit 28 may stop the output of the reception processing data 124, output a notice 126 indicative of the stop of the receiving operation and supply it to the control circuit 16 via the input/output circuit 30.

Particularly in the present embodiment, the comparison circuit 28 generates reception processing data 124, based on the reception data 116 depending upon the reception data selection signal 132 supplied from the input/output circuit 30. The comparison circuit 28 outputs, for example, any of a portion, i.e., real data related to part of the reception data 116, and portions, i.e., all data related to all thereof as the reception processing data 124. Further, the comparison circuit 28 may take a portion intended for reception processing at the control circuit 16 as real data.

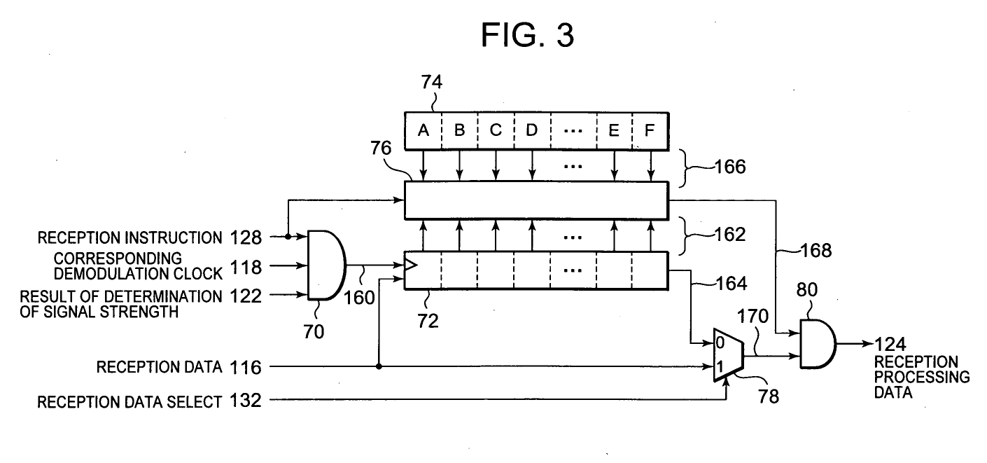

In the present embodiment, the comparison circuit 28 is configured including a comparison control circuit 70, a reception shift register 72, a comparison data storage register 74, a comparison executing section 76, a reception data selector 78 and a data output control circuit 80 as shown in FIG. 3, for example.

The comparison control circuit 70 is operated in response to the control signal 128 supplied from the control circuit 16. The comparison control circuit 70 supplies the corresponding demodulation clock 118 supplied from the demodulator 22 to the reception shift register 72 as a reception shift register input clock 160 depending upon the result of determination 122 from the determinator 26. The control circuit 70 outputs the input clock 160 where, for example, the control signal 128 instructs reception and the result of determination 122 indicates the continuation of the receiving operation, and does not output it when other than above.

The reception shift register 72 is a shift register which fetches the reception data 116 from the demodulator 22 in sync with the corresponding demodulation clock 118 sent from the comparison control circuit 70. The reception shift register 72 may have an internal register of n bytes (where n: integer), for example. In the present embodiment, the reception shift register 72 may be configured using an internal register having capacity, i.e., the number of bytes corresponding to the specs or forms of the present apparatus 10 and the system 50 to which the present apparatus 10 is applied. The internal register may be one of 63 bytes or so, for example.

The reception shift register 72 functions as a serial-parallel converter with respect to the comparison executing section 76. The reception shift register 72 parallel-transmits data at the internal register to the comparison executing section 76 as data 162 intended for comparison. On the other hand, the reception shift register 72 serial-transmits data subsequent to the completion of a comparison operation, of the reception data 116, which is left behind without being subjected to the parallel transmission, i.e., real data 164 to the data output control circuit 80.

The comparison data storage register 74 stores therein comparison data for determining whether the received radio wave is destined for the present apparatus 10. The comparison data storage register 74 stores a reception data string of network addresses or the like, for example. The comparison data storage register 74 of the present embodiment stores therein comparison data in advance. The comparison data storage register 74 may store comparison data 134 supplied via the input/output circuit 30 from the control circuit 16.

The comparison executing section 76 actually compares the register data 162 intended for comparison, parallel-transmitted from the reception shift register 72 with the comparison data 166 stored in the comparison data storage register 74, and determines whether the corresponding radio wave corresponding to the source of the reception data 116 is destined for the present apparatus 10. When the register data 162 and the comparison data 166 coincide with each other from the above result of determination, the comparison executing section 76 judges that the corresponding radio wave is destined for the present apparatus 10. Further, the comparison executing section 76 permits the output of reception processing data 124 from the data output control circuit 80 and sets the result of comparison 168 notified to the data output control circuit 80 to an output permission. At other times, the comparison executing section 76 sets a non-permission and notifies it to the data output control circuit 80.

The reception data selector 78 outputs any of the real data 164 supplied from the reception shift register 72, and the reception data 116 supplied from the demodulator 22, i.e., all data to the data output control circuit 80 as selection data 170 according to the reception data selection signal 132 supplied from the input/output circuit 30. The reception data selector 78 outputs the real data 164 as the selection data 170 when the reception data selection signal 132 is 0, for example, and outputs all data 116 as the selection data 170 when the reception data selection signal 132 is 1.

Only when the result of comparison 168 by the comparison executing section 76 indicates the output permission, the data output control circuit 80 outputs the selection data 170 supplied from the reception data selector 78 as reception processing data 124. When other than the above, the data output control circuit 80 stops its output.

The input/output circuit 30 may be a host interface having the function of mutually transmitting digital data between the transmitter-receiver 14 and the control circuit 16. In the present embodiment, the input/output circuit 30 is connected to an input/output circuit 40 in the control circuit 16 via the connecting lines 102 and 104 and swaps the digital data and control signals with the input/output circuit 40.

When, for example, the present apparatus 10 performs its receiving operation, the input/output circuit 30 notifies a control signal 128 indicative of a reception instruction notified from the control circuit 16 via the connecting line 102 to the RF circuit 20, the demodulator 22, the RSSI detector 24, the determinator 26, the comparison circuit 28 and the modulator 32 according to the reception instruction. Further, the input/output circuit 30 supplies the reception processing data 124 supplied from the comparison circuit 28 to the control circuit 16 via the connecting line 104.

On the other hand, when the present apparatus 10 performs it transmitting operation, the input/output circuit 30 notifies a control signal 130 indicative of a transmission instruction notified from the control circuit 16 via the connecting line 102 to the RF circuit 20 and the modulator 32 according to the transmission instruction. Then, the input/output circuit 30 receives therein transmission data from the control circuit 16 via the connecting line 102 and supplies the transmission data 136 to the modulator 32.

The input/output circuit 30 of the present embodiment has, for example, a register and stores the reception data selection signal supplied via the connecting line 102 from the control circuit 16 in the register. When the present apparatus 10 performs its receiving operation, the input/output circuit 30 may supply the reception data selection signal 132 read from the register to the comparison circuit 28.

The modulator 32 effects modulation processing on the digital transmission data 136 supplied via the input/output circuit 30 from the control circuit 16, particularly in the present embodiment, performs digital-to-analog conversion on the same to produce analog transmission data 138, followed by supply to the RF circuit 20.

The control circuit 16 has the function of controlling and generally managing the operation of the whole present apparatus. The control circuit 16 supplies both a control signal indicative of transmitting/receiving operations and transmission data to the transmitter-receiver 14 via the connecting line 102 and receives a receiving operation stop notice and reception processing data from the transmitter-receiver 14 via the connecting line 104. When the receiving operation stop notice is accepted from the determinator 26 or the comparison circuit 28 in the transmitter-receiver 14, the control circuit 16 may supply the control signal 102 for instructing the stop of the receiving operation over the whole transmitter-receiver 14 to the transmitter-receiver 14.

Upon the receiving operation of the present apparatus 10, the control circuit 16 of the present embodiment may determine comparison data used in the comparison circuit 28 of the transmitter-receiver 14 and set it to the comparison circuit 28. The comparison data is determined by the system 50 to which the present apparatus 10 is applied. When the reception data subjected to reception processing by the present apparatus 10 is formed in, for example, a data format comprised of fields such as {synchronous data}, {recognition data}, {data length}, {address} and {data}, etc., ones other than the {data} field actually necessary for reception processing, i.e., {synchronous data}, {recognition data}, {data length} and {address} may be set as the comparison data.

In order to perform reception processing on the reception data supplied from the transmitter-receiver 14, the control circuit 16 of the present embodiment may set a reception data selection signal indicating 1 when a portion related to the comparison data is needed, and indicating 0 when other than the above, to the input/output circuit 30 of the transmitter-receiver 14. Whether the comparison data portion is needed upon the reception processing is determined by the system 50 to which the present apparatus 10 is applied. However, the control circuit 16 may determine whether the comparison data portion is required. When, for example, the circumstances under which the present apparatus 10 is placed, such as the time when the connection of the present apparatus 10 to the wireless network system 50 is started, and the time when the set contents are changed, have changed at the startup of the present apparatus 10, the control circuit 16 may set the reception data selection signal to 1.

Since the reception data supplied from the transmitter-receiver 14 has the portion related to the comparison data, such a control circuit 16 may set comparison data based on this portion to the comparison circuit 28 of the transmitter-receiver 14 when the reception data selection signal is set to 1.

In the present embodiment, the control circuit 16 is configured including the input/output circuit 40, a controller 42 and a timer 44 as shown in FIG. 1 by way of example.

The input/output circuit 40 may be a host interface having the function of mutually transmitting digital data between the transmitter-receiver 14 and the control circuit 16. In the present embodiment, the input/output circuit 40 is connected to the input/output circuit 30 in the transmitter-receiver 14 via the connecting lines 102 and 104 and swaps the digital data and control signals with the input/output circuit 30.

The controller 42 supplies a control signal 140 indicative of a setting time such as a reception start time or the like to the timer 44 to control it. Further, the controller 42 supplies a control signal 144 for instructing the receiving or transmitting operation of the present apparatus 10 to the transmitter-receiver 14 via the input/output circuit 40 in accordance with a setting time expiration notice 142 supplied from the timer 44.

Upon the receiving operation, the controller 42 controls the present apparatus 10 in response to reception processing data 146 sent from the transmitter-receiver 14 via the input/output circuit 40 to execute the storage and analysis of the reception processing data 146 and its instruction. Upon the transmitting operation, the controller 42 sets or builds up transmission data 144 indicative of a desire for transmission and supplies the same to the transmitter-receiver 14 via the input/output circuit 40.

In response to the control signal 140 indicative of the setting time sent from the controller 42, the timer 44 counts the setting time and supplies the setting time expiration notice 142 to the controller 42 when count expiration is reached.

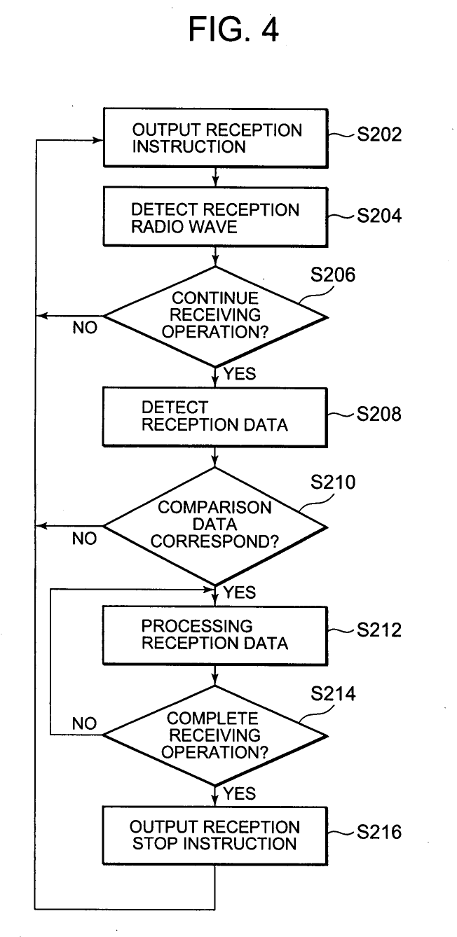

An example of the receiving operation of the data transmitting/receiving apparatus 10 according to the present embodiment will next be explained with reference to a flowchart shown in FIG. 4.

In the present embodiment, the timer 44 in the control circuit 16 first counts a reception start time set by the controller 42 and notifies a setting time expiration notice 142 to the controller 42 when the setting time is expired.

The controller 42 issues a reception start instruction in accordance with the setting time expiration notice 142 and supplies a control signal 144 for instructing the reception start to the transmitter-receiver 14 via the input/output circuit 40 (S202).

Next, a control signal 128 for instructing the receiving operation is supplied from the input/output circuit 30 to each section in accordance with the reception start instruction sent from the control circuit 16 to start the receiving operation of the present apparatus 10. Thus, the present apparatus 10 is brought into a state capable of receiving a radio wave. For example, a predetermined radio wave is received by the antenna 12 and an RF signal based on the radio wave is inputted to the RF circuit 20 (S204).

At this time, the RF circuit 20 converts the RF signal into analog form to produce analog reception data 112 and 114.

The reception data 112 is supplied to the demodulator 22, where it is subjected to demodulation processing such as analog-to-digital conversion to produce digital reception data 116. The reception data 116 is supplied to the comparison circuit 28 together with demodulation clocks 118 outputted from the demodulator 22.

The reception data 114 is supplied to the RSSI detector 24, where a signal strength based on the data 114 is detected. The signal strength is analog-to-digital converted to produce digital data 120 indicative of the signal strength.

The signal strength 120 is supplied to the determinator 26 where it is compared with a predetermined threshold value, whereby it is determined whether the receiving operation of the present apparatus 10 should be continued or stopped (S206).

When it is found from the result of determination at Step S206 that the receiving operation should be continued, the flowchart proceeds to Step S206, where the result of determination 122 indicating that the receiving operation should be continued is notified to the comparison circuit 28, where the reception data is compared with it. On the other hand, when it is determined that the receiving operation should be stopped, the result of determination 122 indicating that the receiving operation should be stopped is notified to the comparison circuit 28. Therefore, the flowchart thereafter returns to Step S202 without performing comparison processing.

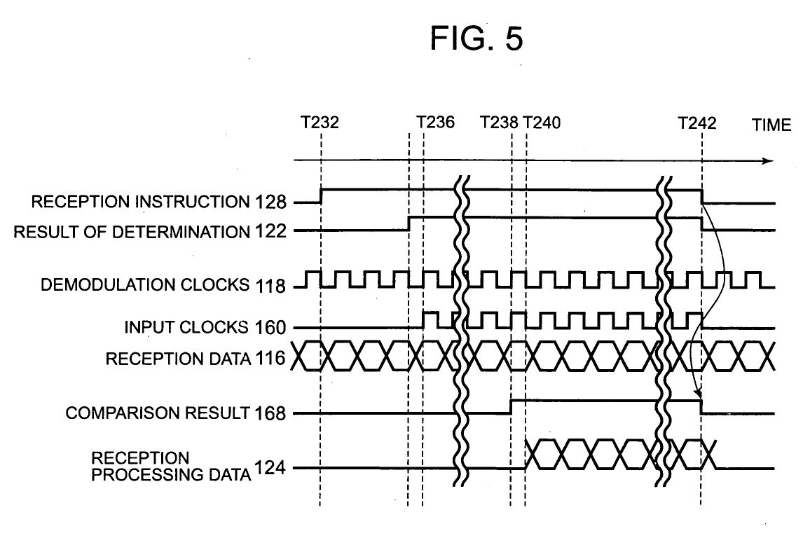

At Step S208, the reception data 116, the demodulation clocks 118 and the result of determination 122 indicating that the receiving operation should be continued are supplied to the comparison circuit 28 where comparison processing is performed. An example of the operation of the comparison circuit 28 will be explained in conjunction with a timing chart shown in FIG. 5.

In the comparison circuit 28, the demodulation clocks 118, the result of determination 122 and the reception instruction 128 are inputted to the comparison control circuit 70. In the control circuit 70, the reception instruction 128 is brought to 1 at a time T232 and indicates or instructs a receiving operation, and the result of determination 122 is brought to 1 at a time T234 and instructs the continuation of the receiving operation. Therefore, the corresponding modulation clock 118 is supplied to the reception shift register 72 as a reception shift register input clock 160 from a time T234 (T236). The reception data 116 is inputted to the reception shift register 72 in sync with this input clock 160.

When the reception data 116 is charged into the corresponding register of the reception shift register 72, its register data 162 is parallel-transmitted to the comparison executing section 76, and the real data 164 at the reception data 116 is serially transmitted to the reception data selector 78.

At the comparison executing section 76, the register data 162 is compared with the corresponding comparison data 166 stored in the comparison data storage register 74 (S210). When they are found not to coincide with each other, the flowchart returns to Step S202 without outputting the reception processing data 124. When they coincide with each other, the flowchart proceeds to Step S212, where the result of comparison 168 indicative of an output permission is notified to the data output control circuit 80 (T238).

At the reception data selector 78, either of the real data 164 and the reception data 116 is outputted to the data output control circuit 80 according to the corresponding reception data selection signal 134. When, for example, the reception data selection signal 134 of 0 is supplied, the real data 164 is outputted to the control circuit 80 as selection data 170.

Since the result of comparison 168 indicative of the output permission is notified to the data output control circuit 80, the selection data 170 is sequentially outputted to the input/output circuit 30 as reception processing data 124 (T240).

The reception processing data 124 is supplied to the control circuit 16 via the input/output circuit 30. The control circuit 16 analyzes the reception processing data 124 to receive desired data and determines whether the reception is completed (S214).

When it is judged from the result of determination at S214 that the reception has not yet been completed, the processing of reception data at Step S212 is continued. When, however, the completion of reception is detected, the flowchart proceeds to Step S216, where a reception stop instruction is issued and notified to the transmitter-receiver 14 via the connecting line 102.

The reception stop instruction 102 is supplied to each section as the control signal 128 by the input/output circuit 30. The reception stop instruction 102 is supplied to, for example, the determinator 26 to stop the determination of the signal strength. Further, the reception stop instruction 102 is supplied to the comparison circuit 28 to stop the comparison processing and the output of the reception processing data 124 (T242).

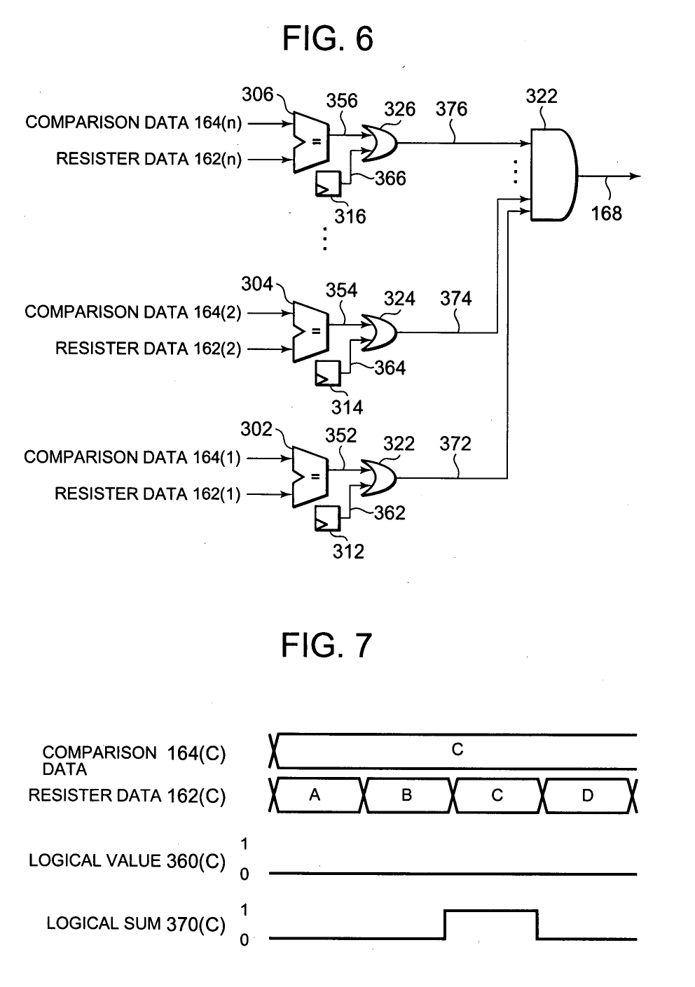

In the data transmitting/receiving apparatus 10 according to the present embodiment, the comparison executing section 76 contained in the comparison circuit 28 of the transmitter-receiver 14 is configured including a plurality of comparators 302, 304 and 306, a plurality of enable registers 312, 314 and 316, a plurality of comparison result output parts 322, 324 and 326, and a comparison result determination circuit 332 as shown in FIG. 6, for example. The comparison executing section 76 can determine or fix up bytes undesired for comparison in the register data 162 according to logic values set to the plurality of enable registers 312, 314 and 316.

Actually, the comparison executing section 76 can contain comparators, enable registers and comparison result output parts every byte of the internal register in the reception shift register 72. In order to avoid an increase in complexity, only a small number of comparators, enable registers and comparison result output parts are shown in FIG. 6. The comparison executing section 76 may contain comparators, enable registers and comparison result output parts n by n respectively in association with the internal register of n bytes, for example. The comparators, enable registers and comparison result output parts have a correlation to one another every byte.

For example, a comparator 300(a) corresponding to an ath byte (where 1≦a≦n) inputs data 162(a) and 164(a) of the ath byte at register data 162 and comparison data 164 therein respectively and compares them. When they coincide with each other, the comparator 300(a) outputs a logic value indicative of 1. When they do not coincide with each other, the comparator 300(a) outputs a logic value indicative of 0. The comparator 300(a) supplies each logic value to a comparison result output part 320(a) corresponding to the ath byte.

The comparators 302, 304 and 306 of the present embodiment respectively correspond to a 1st byte, a 2nd byte and an nth byte of the internal register. The comparator 302 inputs register data 162(1) and comparison data 164(1) therein and compares them, and outputs a comparison result 352 therefrom as its result. Similarly, the comparators 304 and 306 input register data 162(2) and comparison data 164(2), and register data 162(n) and comparison data 164(n) therein and compare them, respectively, and outputs comparison results 354 and 356 therefrom as their results.

The plurality of enable registers 312, 314 and 316 are respectively control registers to which logic values are set by the control circuit 16 and which store the same therein. For example, an enable register 310(a) corresponding to the ath byte supplies a logic value set by the control circuit 16 to the comparison result output part 320(a) corresponding to the ath byte.

The enable registers 312, 314 and 316 respectively set a logic value indicative of 1 as registers corresponding to bytes that ignore comparison if no influence is effected on a decision as to whether the register data 162(1), register data 162(a) and register data 162(n) are destined for the present apparatus even though the comparison is ignored, and respectively set a logic value indicative of 0 when other than it.

The enable registers 312, 314 and 316 correspond to the 1st byte, 2nd byte and nth byte and supply logic values 362, 364 and 366 to the comparison result output parts 322, 324 and 326, respectively.

The comparison result output part 322 is a control circuit which ORs the comparison result 352 outputted from the comparator 302 and the logic value 362 outputted from the enable register 312. If either of them indicates 1, then the comparison result output part 322 outputs a logical sum or ORing 372 indicative of 1 to the comparison result determination circuit 332. When other than it, the comparison result output part 322 outputs a logical sum or ORing 372 indicative of 0 to the comparison result determination circuit 332. Similarly, the comparison result output parts 324 and 326 make a logical sum or ORing 374 of the comparison result 354 and the logic value 364 and a logical sum or ORing 376 of the comparison result 356 and the logic value 366 respectively and output the same to the comparison result determination circuit 332.

The comparison result determination circuit 332 is a logic circuit which inputs the plurality of logical sums 372, 374 and 376 from the plurality of comparison result output parts 322, 324 and 326. The comparison result determination circuit 332 outputs a comparison result 168 indicating 1 when these logical sums are all indicative of 1 and indicating 0 when other than it.

The control circuit 16 of the present embodiment can decide bytes inapplicable to comparison, of the bytes, i.e., comparison data ignored for comparison of the register data 162 by the comparison executing section 76.

The control circuit 16 produces, for example, comparison control data indicative of bytes intended for comparison and bytes unintended for comparison in association with the respective bytes that constitute the comparison data. The control circuit 16 may generate comparison control data which are identical to the comparison data 164 in the number of bytes, i.e., equal to the internal register in capacity, and in which 0 is set to the bytes intended for comparison and 1 is set to the bytes that ignore comparison. The control circuit 16 supplies the same to the comparison circuit 28 of the transmitter-receiver 14 and sets the same to the plural enable registers 312, 314 and 316 of the comparison executing section 76.

The control circuit 16 may produce comparison control data according to the specs or forms of the present apparatus 10 and the system 50 to which the present apparatus 10 is applied. When the circumstances under which the present apparatus 10 is placed, have changed, the control circuit 16 may change comparison control data.

When the reception data subjected to reception processing by the present apparatus 10 is formed in, for example, a data format comprised of fields such as {synchronous data}, {recognition data}, {data length}, {address} and {data}, etc., the {data} changes for every reception data, and the {data length} changes corresponding to the {data}. Therefore, the control circuit 16 of the present embodiment may generate such comparison control data as to ignore the {data length}.

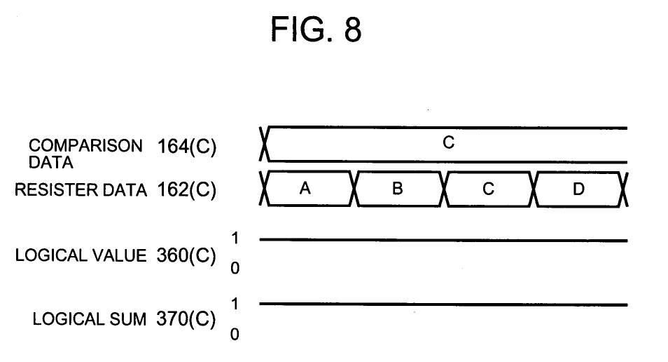

An example of the operation of the comparison executing section 76 shown in FIG. 6 in the data transmitting/receiving apparatus 10 according to the present embodiment will next be explained with reference to timing charts shown in FIGS. 7 and 8.

When, for example, a logic value indicative of 0 is set to an enable register 310(C) corresponding to a Cth byte, the enable register 310(C) outputs a logic value 360(C) always indicating 0 as shown in FIG. 7.

Now, a comparator 300(C) corresponding to the Cth byte compares register data 162(C) and comparison data 164(C) corresponding to the Cth byte. The comparator 300(C) outputs a result of comparison 350(C) indicating 1 when they coincide with each other and indicating 0 when other than it.

Since the logic value 360(C) always indicates 0 at a comparison result output part 320(C) corresponding to the Cth byte, the same value as the comparison result 350(C) is outputted to the comparison result determination circuit 332 as a logic value 370(C).

Thus, if the logic value set to each enable register is indicative of 0 at a predetermined byte, then the value indicated by the result of comparison at the corresponding comparator is supplied to the comparison result determination circuit 332.

On the other hand, when a logic value indicative of 1 is set to the enable register 310(C), a logic value 360(C) always indicative of 1 is outputted from the enable register 310(C) as shown in FIG. 8.

The comparator 300(C) outputs a result of comparison 350(C) indicating 1 when the register data 162(C) and the comparison data 164(C) coincide with each other and indicating 0 when other than it.

Since, however, the logic value 360(C) is always indicative of 1 particularly in the present embodiment, the comparison result output part 320(C) outputs a logic value 370(C) indicative of 1 to the corresponding comparison result determination circuit 332 regardless of the value indicated by the result of comparison 350(C).

Thus, if the logic value set to the corresponding enable register is indicative of 1 at the predetermined byte, the value indicative of 1 is supplied from the comparison result output part to the comparison result determination circuit 332 regardless of the result of comparison by the comparator. Accordingly, even when the register data at the predetermined byte is different from the comparison data, the comparison result determination circuit 332 receives the logic value indicative of 1 therein. Therefore, if register data of other bytes coincide with the comparison data, then the comparison result determination circuit 332 receives the logic sum indicative of 1 from all comparison result output parts. Thus, the comparison result determination circuit 332 can output the result of comparison 168 indicative of an output permission.

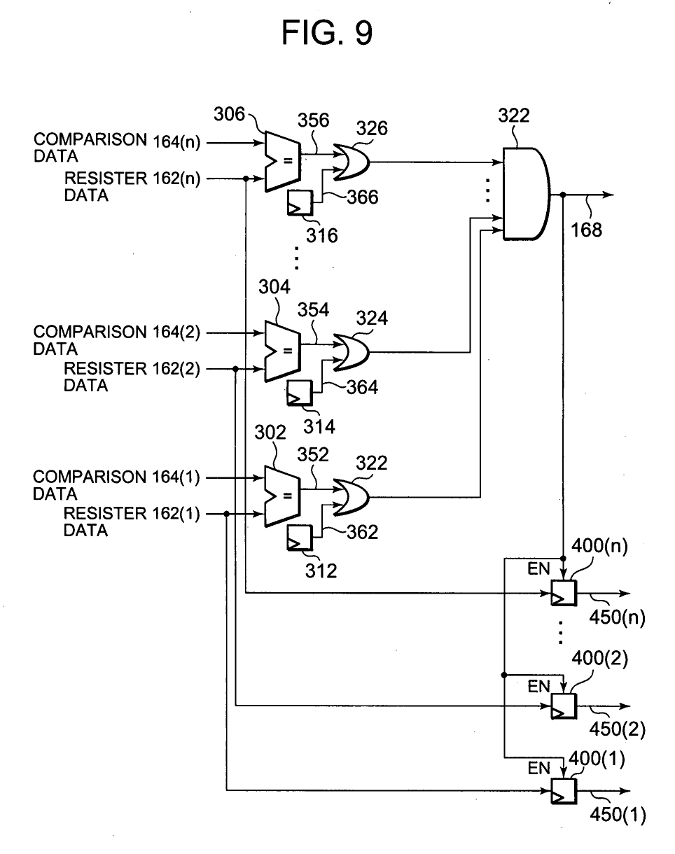

In the data transmitting/receiving apparatus 10 according to the present embodiment, the comparison executing section 76 included in the comparison circuit 28 of the transmitter-receiver 14 may be configured including a plurality of mask data holding circuits 402, 404 and 406 as shown in FIG. 9 by way of example in addition to the configuration shown in FIG. 6. The comparison executing section 76 can supply mask data held in the plural mask data holding circuits 402, 404 and 406 to the control circuit 16.

The comparison executing section 76 can actually include mask data holding circuits every byte of the internal register in the reception shift register 72. However, only a small number of mask data holding circuits are shown in FIG. 9 to avoid an increase in complexity. The comparison executing section 76 may preferably include n mask data holding circuits in association with n-byte internal registers, for example.

For instance, a mask data holding circuit 400(a) corresponding to an ath byte inputs register data 162(a) therein and stores and holds the register data 162(a) as mask data 450(a) in accordance with the result of comparison 168 indicative of the output permission, for example, with the result of comparison 168 by the comparison result determination circuit 332 as a trigger. Thus, the mask data holding circuit 400(a) stores the register data 162(a) at the coincidence of comparison as the mask data 450(a) therein. The mask data holding circuit 400(a) may store the mask data 450(a) indicative of 0 as an initial value.

The mask data holding circuits 402, 404 and 406 employed in the present embodiment respectively correspond to a 1st byte, a 2nd byte and an nth byte of the internal register. The mask data holding circuit 402 inputs register data 162(1) therein and stores the same as mask data 450(1) depending on the result of comparison 168. Similarly, the mask data holding circuits 404 and 406 respectively input register data 162(2) and register data 162(n) therein and stores the same as mask data 450(2) and 450(n) in accordance with the result of comparison 168.

The mask data holding circuit 400(a) continues to output the stored mask data 450(a) during the operation of the comparison executing section 76. The comparison executing section 76 may continue to output mask data 450 constituted of mask data 450(1) through 450(n).

Based on the mask data 450 supplied from such a comparison executing section 76, the control circuit 16 of the present embodiment can obtain information about register data that changes every reception data.

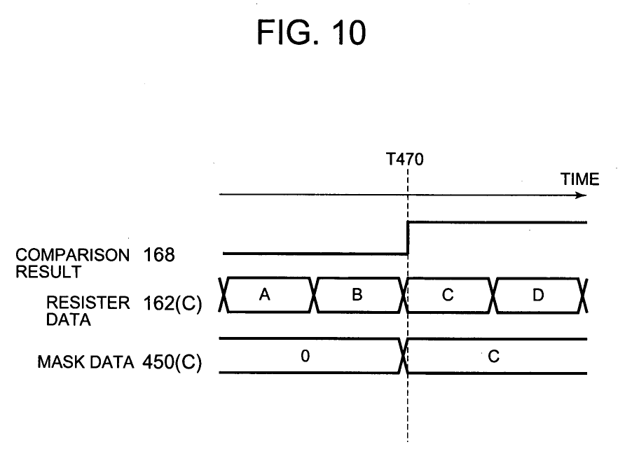

An example of the operation of each of the mask data holding circuits included in the comparison executing section 76 shown in FIG. 9 in the data transmitting/receiving apparatus 10 according to the present embodiment will next be described with reference to a timing chart shown in FIG. 10.

When, for instance, a mask data holding circuit 400(C) corresponding to a Cth byte is supplied with the result of comparison 168 indicative of 0, i.e., an output non-permission, input register data 162 (C) is not stored in the holding circuit 400(C), and mask data 450(C) indicative of an initial value is outputted.

Since, however, the result of comparison 168 indicative of 1, i.e., an output permission is supplied to the mask data holding circuit 400(C) at a time T470, register data 162(C) is stored in the holding circuit 400(C) as mask data 450(C), and the stored mask data 450(C) is outputted since a time T470.

The data transmitting/receiving apparatus 10 according to the present invention can be applied to all communication devices each of which analyzes fixed reception data.

While the preferred forms of the present invention have been described, it is to be understood that modifications will be apparent to those skilled in the art without departing from the spirit of the invention. The scope of the invention is to be determined solely by the following claims.

What is claimed is:

1. A data transmitting/receiving apparatus comprising:
transmitting/receiving means for transmitting and receiving desired reception data and transmission data by radio waves; and
control means for controlling transmission/reception of the reception data and the transmission data and performing reception processing on reception processing data based on the reception data,
wherein the transmitting/receiving means includes comparing means for comparing data intended for comparison, corresponding to at least part of the reception data with predetermined comparison data to thereby determine whether the reception data is destined for the present apparatus, outputting the reception processing data when the reception data is destined for the present apparatus and supplying the same to the control means, and
wherein the comparing means outputs any of real data related to part of the reception data and all data related to all thereof as the reception processing data in accordance with a reception data selection signal set to the control means.

2. The data transmitting/receiving apparatus according to claim 1, wherein the comparing means sets a portion excluding the data intended for comparison, of the reception data as the real data.

3. The data transmitting/receiving apparatus according to claim 1, wherein in order to perform reception processing on the reception processing data, the control means sets the reception data selection signal indicating 1 when the data intended for comparison, of the reception data is necessary and indicating 0 when other than the above to the comparing means, and
wherein the comparing means sets the real data as the reception processing data when the reception data selection signal is 0 and sets said all data as the reception processing data when the reception data selection signal is 1.

4. The data transmitting/receiving apparatus according to claim 3, wherein the transmitting/receiving means converts the received radio wave into analog form and effects demodulation processing thereon to produce the reception data, and
wherein the comparing means includes comparison executing means for actually comparing the data intended for comparison and the predetermined comparison data, selecting means for selecting the real data and the all data in accordance with the reception data selection signal and setting the selected data as the reception processing data, and a shift register for parallel-transmitting the data intended for comparison, of the reception data to the comparison executing means and serially transmitting the real data to the selecting means.

5. The data transmitting/receiving apparatus according to claim 1, wherein the control means determines bytes corresponding to a comparison and bytes non-corresponding to the comparison in association with respective bytes of the predetermined comparison data, produces comparison control data indicative of the result of determination thereof and sets the same to the comparing means, and
wherein the comparing means determines according to the comparison control data whether the reception data is destined for the present apparatus in disregard for at least part of the result of comparison between the data intended for comparison and the predetermined comparison data.

6. The data transmitting/receiving apparatus according to claim 5, wherein the control means determines comparison control information on the respective bytes, using logic values indicating 1 for the bytes corresponding to the comparison and indicating 0 for the bytes non-corresponding to the comparison, in association with the respective bytes of the comparison data, and produces the comparison control data constituted of the comparison control information about the respective bytes, and
wherein the comparing means compares the data intended for comparison and the predetermined comparison data every byte, consequently obtains, every byte, a result of comparison indicating 1 when they coincide with each other and indicating 0 when they are different from each other, calculates logical sums of the comparison results for the respective bytes and the comparison control information on the respective bytes every byte, and determines that the reception data is destined for the present apparatus when the logical sums of the respective bytes are all 1.

7. The data transmitting/receiving apparatus according to claim 1, wherein the comparing means includes holding means for storing the data intended for comparison as mask data when it is determined that the reception data is destined for the present apparatus, and
wherein the holding means supplies the stored mask data to the control means.

8. The data transmitting/receiving apparatus according to claim 7, wherein the holding means stores 0 therein every byte as an initial value of the mask data, and supplies the always-stored mask data to the control means during a period in which the comparing means operates to receive the radio wave.

9. A method of analyzing reception data in a data transmitting/receiving apparatus wherein a transmitting/receiving section transmits and receives desired reception data and transmission data by radio waves, and a control section controls transmission/reception of the reception data and the transmission data and further performs reception processing on reception processing data based on the reception data, said method comprising:
a comparing step for allowing the transmitting/receiving section to compare data intended for comparison, corresponding to at least part of the reception data with predetermined comparison data to thereby determine whether the reception data is destined for the present apparatus, and allowing the transmitting/receiving section to output the reception processing data when the reception data is destined for the present apparatus and to supply the same to the control section,
wherein in said comparing step, any of real data related to part of the reception data and all data related to all thereof is outputted as the reception processing data in accordance with a reception data selection signal set to the control section.

10. The method according to claim 9, wherein in said comparing step, a portion excluding the data intended for comparison, of the reception data is set as the real data.

11. The method according to claim 9, wherein in said comparing step, in order to perform reception processing on the reception processing data, the control section sets the real data as the reception processing data when the reception data selection signal is 0, and sets the all data as the reception processing data when the reception data selection signal is 1, using the reception data selection signal indicating 1 when the data intended for comparison, of the reception data is necessary and indicating 0 when other than the above.

12. The method according to claim 11, wherein the received radio wave is converted into analog form and effects demodulation processing thereon to produce the reception data, and
wherein the comparing step includes a comparison executing step for actually comparing the data intended for comparison and the predetermined comparison data, a selecting step for selecting the real data and the all data in accordance with the reception data selection signal and setting the selected data as the reception processing data, and a transmitting step for, using a shift register, parallel-transmitting the data intended for comparison, of the reception data so as to be used in the comparison executing step and serially transmitting the real data so as to be used in the selecting step.

13. The method according to claim 9, wherein in said comparing step, the control section determines bytes corresponding to a comparison and bytes non-corresponding to the comparison in association with respective bytes of the predetermined comparison data and uses comparison control data produced so as to indicate the result of determination, and
wherein the control section determines according to the comparison control data whether the reception data is destined for the present apparatus in disregard for at least part of the result of comparison between the data intended for comparison and the predetermined comparison data.

14. The method according to claim 13, wherein in said comparing step, when the control section determines comparison control information on the respective bytes, using logic values indicating 1 for the bytes corresponding to the comparison and indicating 0 for the bytes non-corresponding to the comparison, in association with the respective bytes of the comparison data, and produces the comparison control data constituted of the comparison control information about the respective bytes,
the control section compares the data intended for comparison and the predetermined comparison data every byte, consequently obtains, every byte, results of comparison indicating 1 when they coincide with each other and indicating 0 when they are different from each other, calculates logical sums of the comparison results for the respective bytes and the comparison control information on the respective bytes every byte, and determines that the reception data is destined for the present apparatus when the logical sums of the respective bytes are all 1.

15. The method according to claim 9, wherein the comparing step includes a holding step for storing the data intended for comparison as mask data when it is determined that the reception data is destined for the present apparatus, and
wherein in said holding step, the stored mask data is supplied to the control section.

16. The method according to claim 15, wherein in said holding step, 0 is stored every byte as an initial value of the mask data, and the always-stored mask data is supplied to the control section during a period in which the comparing step is in operation to receive the radio wave.
